(19) United States
(12) Patent Application Publication
(10) Pub. No.: US 2009/0009322 A1
(43) Pub. Date: Jan. 8, 2009

(54) System and method for position location in an enclosed environment

(76) Inventors: Alejandro Ramirez, Munich (DE); Christian Schwingenschlogl, Putzbrunn (DE)

Correspondence Address: HARNESS, DICKEY & PIERCE, P.L.C., P.O.BOX 8910, RESTON, VA, 20195, US

(21) Appl. No.: 12/216,390

(22) Filed: Jul. 3, 2008

(30) Foreign Application Priority Data
Jul. 6, 2007 (DE) 10 2007 031 485.1
Sep. 25, 2007 (DE) 10 2007 045 742.3

(51) Int. Cl. H04Q 7/00

(52) U.S. Cl. 340/539.13

(57) ABSTRACT

A system and method are disclosed for position location in an enclosed environment. In at least one embodiment, the system includes an enclosed environment with several distributed RFID transponders and an RFID processing unit for wireless communication with the RFID transponders via an electromagnetic coupling field. In each of the RFID transponders, an identifier assigned to the respective position of the RFID transponder in relation to the enclosed environment is stored. In at least one embodiment, the RFID transponders and the RFID processing unit are configured in such a way that if the RFID processing unit is positioned such that at least one RFID transponder is within a transmission range of the electromagnetic coupling field, the identifier of the RFID transponder is automatically transmitted to the RFID processing unit.

### PRIORITY STATEMENT

The present application hereby claims priority under 35 U.S.C. §119 on German patent application numbers DE 10 2007 031 485.1 filed Jul. 6, 2007 and DE 10 2007 045 742.3 filed Sep. 25, 2007, the entire contents of each of which is hereby incorporated herein by reference.

### FIELD

Embodiments of the invention are generally in the technical field of position location and generally relate to an RFID transponder-based system and/or method for position location in an enclosed environment.

### BACKGROUND

In satellite-based position location systems satellites in orbit continuously transmit their current position and time by way of electromagnetic signals which can be used by signal receivers for position location on the basis of transit time measurements.

Such a satellite-based position location system requires as a rule an unimpeded view of the receiver to at least three satellites, which is not always possible because of shadowing. In particular, such systems cannot be deployed in enclosed environments, or can only be deployed very restrictedly, as the signals transmitted by the satellites are reflected and badly attenuated by walls and ceilings. This is especially the case for industrial buildings which frequently contain metal structures.

Over recent years optical and acoustic systems have been increasingly developed for position location in buildings, but the equipment for them is comparatively expensive. Furthermore, such systems require elaborate calibration before use so that undesired signal reflections on walls and ceilings can be filtered out, which in turn requires an exact knowledge of the architecture of the enclosed environment.

Position location systems based on WLAN (WLAN=Wireless Local Area Network) and DECT technology (DECT=Digital Enhanced Cordless Telecommunications) have become more widely used but these systems too are affected by the problem of undesired reflection and attenuation of the signals by walls and ceilings, so that their range is limited. In addition, relatively high signal intensities are used, which are not generally permitted in sensitive establishments such as hospitals and schools.

### SUMMARY

In at least one embodiment of the invention, an inexpensive and technically simple system and method are provided for precise position location within an enclosed environment.

According to the proposal of at least one embodiment of the invention, a system and method are disclosed for position location inside an enclosed environment.

In accordance with an initial aspect of at least one embodiment of the invention, a system (or arrangement) for position location within an enclosed environment is shown. The system includes an enclosed environment with several distributed RFID transponders located at fixed points (stationary/permanently installed) and an RFID processing unit for contactless communication with the RFID transponders by way of an electromagnetic field (“electromagnetic coupling field”). The RFID processing unit can for example be a portable data processing unit (computer), such as a handheld computer or PDA (PDA=Personal Digital Assistant), suitably configured as an RFID processing unit.

Stored in each of the RFID transponders is an identifier which identifies the RFID transponder and to which a position of the associated RFID transponder in relation to the enclosed environment (“RFID transponder position”) is assigned. The identifier can be assigned to the position or the position data of the RFID transponder describing the position in a database for example stored in the RFID processing unit. The position data of an RFID transponder describing a position can in particular serve as an identifier.

For indicating the position of an RFID transponder by way of position data a reference system (system of coordinates) is defined for the enclosed environment within which the position of each RFID transponder can be exactly indicated by position data (coordinates). Here and in the further text the term enclosed environment is understood to mean buildings and building complexes such as hospitals, schools, shopping malls and the like in which position location by means of satellite-based position location methods cannot normally be used.

The RFID processing unit is suitably set up for contactless communication with the RFID transponders by way of the electromagnetic coupling field within a selectable transmission range of the coupling field for the transmission of data between the RFID processing unit and the RFID transponders. Through the electromagnetic coupling field the RFID processing unit is electromagnetically coupled with an RFID transponder within the transmission range.

In the system in accordance with at least one embodiment of the invention the RFID transponders and the RFID processing unit are configured in such a way that if the RFID processing unit is positioned anywhere inside the enclosed environment such that at least one RFID transponder is located within the transmission range, the identifier is automatically transmitted to the RFID processing unit.

With the system in accordance with at least one embodiment of the invention it is therefore possible to realize a reliable and at the same time inexpensive method for position location within an enclosed environment by technically simple devices/methods. To determine his/her position a user has merely to carry the RFID processing unit into the enclosed environment and take it into transmission range (communication range) of at least one of the RFID transponders. When the RFID processing unit is taken into transmission range of at least one RFID transponder the position to be determined is as a result set by the user and by automatic transmission of the data (identifier) stored in the RFID transponder the position of the RFID processing unit is determined by the position of the RFID transponder while the RFID processing unit is within transmission range adjacent to the RFID transponder.

In the system in accordance with at least one embodiment of the invention, RFID transponders (RFID=Radio Frequency Identification) based on conventional RFID technology, which are also referred to as “RFID tags”, and an RFID processing unit are used, which are well known as such by the pertinent experts. For a detailed description of the technology, reference can be made for example to the “RFID-Handbuch” (RFID Handbook) by Klaus Finkenzeller, 2002, Hanser-Verlag.

The RFID processing unit and the RFID transponders are configured in such a way that they can exchange data with each other contactlessly by way of an electromagnetic coupling field. The transmission range for communication between the RFID processing unit and the RFID transponders depends significantly on the frequency of the electromagnetic coupling field, the transmission strength of the RFID processing unit, the antenna length and various environmental factors.

Typically the RFID processing unit includes for this purpose an electronic control unit (microprocessor) in the form of an integrated circuit and a high-frequency (HF) interface with an antenna. By way of the HF interface an electromagnetic alternating field can be generated which serves in particular to supply energy to the RFID transponders, to modulate signals to be transmitted to the RFID transponders and to demodulate signals from the RFID transponders. Data transmission is controlled by the control unit on the basis of control commands from an implemented application software. Each RFID transponder comprises an HF interface with an antenna and an integrated circuit which is equipped in particular with a memory for the digital storage of data. Passive transponders are supplied with energy via their HF interface by means of capacitive and/or inductive coupling to the electromagnetic field generated by the RFID processing unit, whereas active transponders have their own energy supply. To transmit data to the RFID processing unit the HF interface of the transponders is equipped with a modulator which modulates a response signal corresponding to the digitally stored data.

In an advantageous embodiment of the system in accordance with at least one embodiment of the invention, the RFID transponders and the RFID processing unit are configured in such a way that the transmission range between the RFID processing unit and the RFID transponders is from 1 to 10 m, which is made possible in particular by equipping the RFID transponders as active transponders in each case with their own energy supply. This has the advantageous result that an RFID transponder located in the enclosed environment is always in transmission range of the RFID processing unit when a user carrying the RFID processing unit approaches the RFID transponder. Such a transmission range can also be achieved by using passive transponders and correspondingly long antennas on the RFID processing unit.

Equally, it may be preferable for the transmission range between the RFID processing unit and the RFID transponders to be from 1 to 10 cm, which can in particular be achieved by equipping the RFID transponders as passive transponders without their own energy supply. This can in particular be advantageous when the position location system is used in sensitive areas such as hospitals and schools in which longer-range radio communication based for example on WLAN and DECT technology is not permitted. In this case the positions of the RFID transponders can be marked appropriately so that the RFID processing unit can be brought so close to an RFID transponder that transmission of the identifier is possible.

In a further advantageous embodiment of the system in accordance with at least one embodiment of the invention the RFID processing unit is configured in such a way that a position corresponding to the most recently transmitted identifier can be shown on a display of the RFID processing unit, so that the user can identify his/her position at any time, for example on a map of the enclosed environment shown on the display. Such a map can be stored in the RFID processing unit. Alternatively, it is also possible for example for such a map to be transferred to the RFID processing unit by a stationary computer via a wireless or wired interface when the user enters an enclosed environment.

In a further advantageous embodiment of the system in accordance with at least one embodiment of the invention destination guidance data for guiding the way to destinations within the enclosed environment are stored in the RFID transponders. Such destination guidance data contain information on the direction that has to be taken to reach a chosen destination. The destinations can be points on the route which are equipped with an RFID transponder. Equally, the destinations may be adjacent to an RFID transponder. The destination guidance data in particular contain information about the next point on the route equipped with an RFID transponder to be headed for in the direction of a specific destination. From each point on the route headed for in this way the destination guidance data stored in the RFID transponder there are transmitted to the RFID processing unit as soon as this RFID transponder is within the transmission range, so that a user always has the latest destination guidance data available according to his/her current position.

In the above embodiment of the system in accordance with at least one embodiment of the invention the RFID processing unit is configured advantageously in such a way that by user interaction a selection of one of the destinations for which destination guidance data are stored in the RFID transponders can be made. On the basis of the destination guidance data transmitted by the RFID transponders to the RFID processing unit destination guidance is provided to the selected destination. For this purpose the RFID processing unit is advantageously configured so that destination guidance is provided by means of optical and/or acoustic signals.

A destination can be selected by manual user interaction, for example by entry on a keypad. It is also possible for example to select a destination by using the RFID processing unit to read an RFID transponder on which the selected destination is stored.

Equally, it is possible in the system in accordance with at least one embodiment of the invention for the RFID processing unit to be configured in such a way that the destinations and the destination guidance data are shown on the display so that without having previously selected a destination a user can optionally follow a destination that is displayed. Furthermore, one of the displayed destinations can be selected simply by user interaction, for example by touching the display if it is configured as a touchscreen.

In accordance with a second aspect of at least one embodiment of the invention, a method for position location is shown in a system as described above. In the method, the RFID processing unit is positioned for wireless communication with the RFID transponders via an electromagnetic coupling field in such a way that at least one RFID transponder is within a transmission range of the electromagnetic coupling field and an identifier assigned to the position of the RFID transponder in relation to the enclosed environment is automatically transmitted to the RFID processing unit. This makes it possible advantageously to realize simple and reliable position location within the enclosed environment.

In an advantageous embodiment of the method in accordance with the invention, if the RFID processing unit is positioned in such a way that at least one RFID transponder is within a transmission range of the electromagnetic coupling field, destination guidance data for guiding the user to destinations within the enclosed environment are transmitted automatically to the RFID processing unit. This makes it possible advantageously to realize simple and reliable destination guidance within the enclosed environment.

At least one embodiment of the invention further extends to the use of a method as described above for position location and destination guidance within an enclosed environment.

### BRIEF DESCRIPTION OF THE DRAWINGS

The invention is now explained in more detail with reference to an example embodiment and to the attached FIGURE.

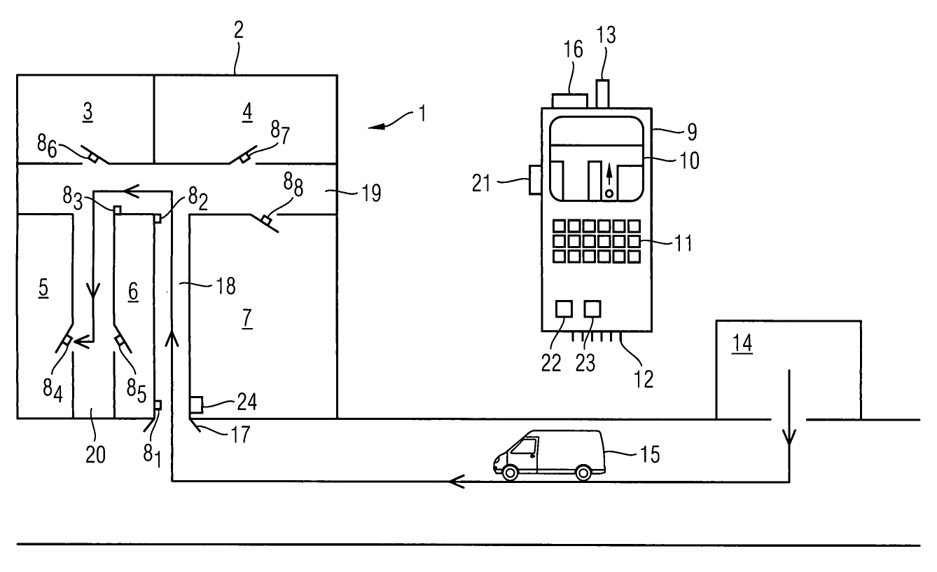

In schematic form, FIG. 1 illustrates an example embodiment of the system or method in accordance with the invention for position location and destination guidance within an enclosed environment.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the FIGURE.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”; and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the FIGURE is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In the embodiment shown in FIG. 1, the position location system designated in total with the reference number 1 includes a shopping mall 2 which as an enclosed building contains several areas in which the shops 3-7 are located. Each shop 3-7 has been assigned its own postal address.

In the shopping mall 2 several permanently installed RFID transponders are distributed, whereby an RFID transponder 8₁ is located in a first passage 18 in the area of an entrance/exit 17 of the shopping mall 2, an RFID transponder 8₂ at a junction of the first passage 18 in a second passage 19, an RFID transponder 8₃ at a junction of a third passage 20 in the second passage 19, an RFID transponder 8₄ on the outside of an entrance door of the third shop 5, an RFID transponder 8₅ on the outside of an entrance door of the fourth shop 6, an RFID transponder 8₆ on the outside of an entrance door of the first shop 3, an RFID transponder 8₇ on the outside of an entrance door of the second shop 4 and an RFID transponder 8₈ on the outside of an entrance door of the fifth shop 7.

Each RFID transponder 8₁-8₈ includes a microchip with a permanent data memory for storing data and an HF interface with antenna for receiving an electromagnetic wave field. The RFID transponders 8₁-8₈ are equipped as active transponders with their own energy supply.

In each of the permanent data memories of RFID transponders 8₁-8₈ an identifier is stored for the purpose of identifying the respective RFID transponder 8₁-8₈, whereby the identifier represents the position data of the associated RFID transponder 8₁-8₈ in relation to the shopping mall 2.

For this purpose a for example two-dimensional reference system is defined for the shopping mall in which every point of the shopping center or every position of an RFID transponder is precisely describable by way of for example two area coordinates.

In addition, in each of the RFID transponders 8₁-8₈ destination guidance data are stored which provide destination guidance to destinations which are equipped with an RFID transponder or are adjacent to an RFID transponder. In the present example, destination guidance data to the first to fifth shop 3-7 are stored in RFID transponder 8₁ located in the area of the entrance/exit 17. The stored destination guidance data contain for each destination the direction to be taken from the current position and the changes in direction which are necessary to reach the destination. Destination guidance can for example also be provided by indicating the direction and distance to points on the route, whereby the points on the route are in each case fitted with an RFID transponder.

Furthermore, system 1 for position location includes an RFID processing unit in the form of a portable handheld computer 9, which is equipped with an RFID processing function by means of a plug-in chip card 16. The chip card 16 is fitted with a program-controlled microprocessor, an HF interface and an antenna, not described in further detail, for generating and receiving an electromagnetic wave field.

In the system 1 the position data stored in an RFID transponder 8₁-8₈ are automatically transmitted to the RFID processing unit 9 when the latter is moved so close to an RFID transponder that the latter is within the transmission range of the generated electromagnetic alternating field. The frequency of the electromagnetic alternating field is for example 900 MHz. The transmitter strength of the RFID processing unit 9 is set in such a way that the range of the electromagnetic alternating field is approx. 10 m.

FIG. 1 shows in schematic form an application in which a parcel has to be taken from a postal logistics center 14 to the third shop 5 in the shopping mall 2.

For this purpose the parcel is loaded into a transport vehicle 15 in the logistics center 14. As is already common practice nowadays, the parcel is fitted with an RFID transponder, in which among other things the delivery address is stored.

An employee of the postal service which is handling delivery of the parcel firstly reads the delivery address of the parcel stored in the RFID transponder using the RFID processing unit 9. Alternatively, it would be possible to enter the delivery address of the parcel manually using the alphanumeric keypad 11 of the RFID processing unit 9.

The RFID processing unit 9 is fitted with a GPS navigation unit 22, by which destination guidance to a selectable destination can be provided on the basis of GPS position data. For this purpose the RFID processing unit 9 is fitted with a GPS receiver, not described in further detail, which can receive GPS signals via an antenna 13. Alternatively, the RFID processing unit 9 can be plugged into a docking station equipped with a GPS receiver, in which GPS position data are transferred to the RFID processing unit 9 via a serial interface 12.

In the present example the employee of the postal service, after reading the parcel's destination address stored in the RFID transponder, places the RFID processing unit 9 in a docking station of the transport vehicle 15, whereupon satellite-based navigation to the parcel's destination address takes place, guiding the employee of the postal service to the entry/exit 17 of the shopping mall 2. For this purpose, direction information in the form of direction symbols and distances are provided on a display 10 of the RFID processing unit 9. In addition, acoustic direction and distance information can be provided by a loudspeaker 21.

At the entrance/exit 17 of the shopping mall 2 the employee of the postal service removes the RFID processing unit 9 from the docking station and fastens it onto a special holder on his/her uniform. He/she then takes the parcel in both hands and walks through the entrance/exit 17 into the first passage 18. Because the signal strength is too low, satellite-based navigation cannot take place inside the shopping mall 2.

A stationary computer 24 equipped with a WLAN transmitter/receiver unit is located in the entrance area of the shopping mall 2. Stored in said computer 24 is a map of the shopping mall on which the points on the route fitted with an RFID transponder and possible destinations within the shopping mall 2 can be shown by way of their position data.

When the employee of the postal service passes the entrance/exits 17 of the shopping mall 2 a WLAN transmitter/receiver unit 23 of the RFID processing unit 9 automatically establishes a wireless link to the stationary computer 24 and the map of the shopping mall 2 is automatically transferred to the RFID processing unit 9 and shown on its display 10, as illustrated in FIG. 1.

When the employee of the postal service passes the entrance/exit 17 of the shopping mall 2 the RFID transponder 8₁ located in the entrance area is also within the transmission range of the RFID processing unit 9, so that the data stored on the RFID transponder 8₁ are automatically transmitted to the RFID processing unit 9. These data are the position data of the RFID transponder 8₁ and the destination guidance data to all destinations equipped with an RFID transponder or adjacent to an RFID transponder within the shopping mall 2. The current position of the employee is then shown on the display 10 of the RFID processing unit 9 by means of a circular symbol. In addition, on the basis of the delivery address for the parcel already stored in the RFID processing unit 9 and the transmitted destination guidance data, a direction indicator is displayed by means of an arrow symbol. Furthermore, the direction to be taken is announced by way of the loudspeaker 21.

If the employee of the postal service moves along the first passage 18, the RFID transponder 8₂ at the junction of the first passage 18 with the second passage 19 enters the transmission range of the RFID processing unit 9, whereupon the data stored on the RFID transponder 8₂—position data and destination guidance data—are automatically transmitted to the RFID processing unit 9.

The current position of the employee is then shown on the display 10 of the RFID processing unit 9 by way of a circular symbol. The destination to be taken (here for example left) is also indicated on the basis of the delivery address stored in the RFID processing unit 9 and the transmitted destination guidance data by means of an arrow symbol. In addition, the destination to be taken is announced by way of the loudspeaker 21.

If the employee of the postal service walks in the correct direction along the second passage 18, the RFID transponder 8₃ located at the junction of a third passage 20 with the second passage 19 enters the transmission range of RFID processing unit 9, whereupon the position data and destination guidance data stored on the RFID transponder 8₃ are automatically transmitted to the RFID processing unit 9 and the current position of the employee is shown on the display 10 of the RFID processing unit 9 by means of a circular symbol along with the direction to be taken (here for example left) on the basis of the stored delivery address and the transmitted destination guidance data by means of an arrow symbol. An announcement of the direction to be taken is also provided by the loudspeaker 21.

If the employee of the postal service moves along the third passage 18, the RFID transponder 8₄ located on the outside of the entrance door of the third shop 5 enters the transmission range of the RFID processing unit 9, whereupon the position data and destination guidance data stored on the RFID transponder 8₄ are automatically transmitted to the RFID processing unit 9 and the position is shown on the display 10 of the RFID processing unit 9 by means of a circular symbol. As the destination has now been reached this can be indicated by a corresponding symbol on the display 10. In addition, an acoustic announcement that the destination has been reached is provided by the loudspeaker 21.

Next it would be possible to automatically show destination guidance for a return route to the entrance/exit 17 of the shopping mall 2 on the display 10.

In the system 1 for position location as in FIG. 1 it would equally be possible to create a wired connection, for example via the serial interface 12, with the stationary computer 24 at the entrance/exit 17 instead of a WLAN link of the RFID processing unit 9. For this purpose the employee of the postal service only has to plug the RFID processing unit 9 into a corresponding socket of the stationary computer 24.

In the event that no destination address is stored in the RFID processing unit 9, a destination address (matching one of the destinations stored in the RFID transponders 8₁-8₈) could be selected by manual interaction, for example by way of the keypad 11 or by way of a cursor shown on the display 10 or by way of a touchscreen pen if the display is configured as a touchscreen.

It would equally be possible for the RFID transponders 8₁-8₈ to be configured as passive transponders. In this case for example a (long) antenna could be integrated in the employee's uniform to realize a transmission range of 1 m to 10 m. For this purpose the RFID processing unit 9 would only have to be connected with the antenna in the uniform in an electrically conductive manner.

With the system in accordance with at least one embodiment of the invention a simple, reliable and inexpensive method for position location and destination guidance (navigation) within an enclosed environment is created which can be easily combined with a satellite-based system for position location and navigation outside the enclosed environment.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system, comprising:
a plurality of RFID transponders distributed in an enclosed environment; and
an RFID processing unit for wireless communication with the RFID transponders via an electromagnetic coupling field, an identifier, assigned to a respective position of the RFID transponder in relation to the enclosed environment, being stored in each of the RFID transponders, and the RFID transponders and the RFID processing unit being configured such that if the RFID processing unit is positioned such that at least one RFID transponder is within a transmission range of the electromagnetic coupling field, the respective identifier of the at least one RFID transponder is automatically transmitted to the RFID processing unit.

2. The system as claimed in claim 1, wherein the RFID transponders and the RFID processing unit are configured such that the transmission range for data transmission between the RFID processing unit and the RFID transponders is between 1 and 10 m.

3. The system as claimed in claim 1, wherein the RFID transponders and the RFID processing unit are configured such that the transmission range for data transmission between the RFID processing unit and the RFID transponders is between 1 and 10 cm.

4. The system as claimed in claim 2, wherein the RFID transponders, as passive transponders, do not have an energy supply of their own.

5. The system as claimed in claim 2, wherein the RFID transponders, as active transponders, are provided with their own energy supply.

6. The system as claimed in claim 1, wherein the RFID processing unit is configured such that a position corresponding to the identifier most recently transmitted by an RFID transponder is displayable on a display of the RFID processing unit.

7. The system for position location as claimed in claim 1, wherein, in each of the RFID transponders, destination guidance data for destination guidance to destinations within the enclosed environment are stored, the RFID transponders and the RFID processing unit being configured such that if the RFID processing unit is positioned such that at least one RFID transponder is within the transmission range of the electromagnetic coupling field, the destination guidance data stored in the RFID transponder are transmitted automatically to the RFID processing unit.

8. The system as claimed in claim 7, wherein the RFID processing unit is configured such that, by user interaction, a destination within the enclosed environment is selectable, and wherein, on the basis of transmitted destination guidance data, destination guidance to the selected destination is provided by at least one of optical and acoustic signals on the RFID processing unit.

9. The system as claimed in claim 7, wherein the RFID processing unit is configured such that the destinations corresponding to the transmitted destination data are shown on a display of the RFID processing unit.

10. A method for operation in an enclosed environment, equipped with several distributed RFID transponders, using an RFID processing unit for wireless communication with the RFID transponders via an electromagnetic coupling field, the method comprising:
automatically transmitting to the RFID processing unit, if the RFID processing unit is positioned such that at least one RFID transponder is within a transmission range of the electromagnetic coupling field, an identifier assigned to a position of the at least one RFID transponder with reference to the enclosed environment.

11. The method as claimed in claim 10, wherein a position corresponding to the identifier most recently transmitted by an RFID transponder is shown on a display of the RFID processing unit.

12. The method as claimed in claim 10, wherein, if the RFID processing unit is positioned such that at least one RFID transponder is within a transmission range of the electromagnetic coupling field, destination guidance data for destination guidance to destinations within the enclosed environment are automatically transmitted to the RFID processing unit.

13. The method as claimed in claim 12, wherein, via user interaction on the RFID processing unit, a destination within the enclosed environment is selected and, based on transmitted destination guidance data, destination guidance is provided to the selected destination by the RFID processing unit via at least one of optical and acoustic signals.

14. The method as claimed in claim 12, wherein destinations belonging to the transmitted destination data are shown on a display of the RFID processing unit.

15. A method, comprising:
using the method as claimed in claim 10 for position location within an enclosed environment.

16. A method, comprising:
using the method as claimed in claim 12 for destination guidance within an enclosed environment.

17. The system as claimed in claim 3, wherein the RFID transponders, as passive transponders, do not have an energy supply of their own.

18. The system for position location as claimed in claim 2, wherein, in each of the RFID transponders, destination guidance data for destination guidance to destinations within the enclosed environment are stored, the RFID transponders and the RFID processing unit being configured such that if the RFID processing unit is positioned such that at least one RFID transponder is within the transmission range of the electromagnetic coupling field, the destination guidance data stored in the RFID transponder are transmitted automatically to the RFID processing unit.

19. The system as claimed in claim 18, wherein the RFID processing unit is configured such that, by user interaction, a destination within the enclosed environment is selectable, and wherein, on the basis of transmitted destination guidance data, destination guidance to the selected destination is provided by at least one of optical and acoustic signals on the RFID processing unit.

20. The system for position location as claimed in claim 3, wherein, in each of the RFID transponders, destination guidance data for destination guidance to destinations within the enclosed environment are stored, the RFID transponders and the RFID processing unit being configured such that if the RFID processing unit is positioned such that at least one RFID transponder is within the transmission range of the electromagnetic coupling field, the destination guidance data stored in the RFID transponder are transmitted automatically to the RFID processing unit.

21. The system as claimed in claim 20, wherein the RFID processing unit is configured such that, by user interaction, a destination within the enclosed environment is selectable, and wherein, on the basis of transmitted destination guidance data, destination guidance to the selected destination is provided by at least one of optical and acoustic signals on the RFID processing unit.

22. The method as claimed in claim 11, wherein, if the RFID processing unit is positioned such that at least one RFID transponder is within a transmission range of the electromagnetic coupling field, destination guidance data for destination guidance to destinations within the enclosed environment are automatically transmitted to the RFID processing unit.

23. The method as claimed in claim 22, wherein, via user interaction on the RFID processing unit, a destination within the enclosed environment is selected and, based on transmitted destination guidance data, destination guidance is provided to the selected destination by the RFID processing unit via at least one of optical and acoustic signals.

24. The method as claimed in claim 22, wherein destinations belonging to the transmitted destination data are shown on a display of the RFID processing unit.
